(19) United States
(12) Patent Application Publication
(10) Pub. No.: US 2026/0348231 A1
(43) Pub. Date: Nov. 5, 2026

(54) SHUTTER ASSEMBLY

(71) Applicant: Louver-Lite Limited, Cheshire (GB)

(72) Inventor: Andrew Greening, Cheshire (GB)

(73) Assignee: Louver-Lite Limited, Cheshire (GB)

(21) Appl. No.: 19/119,841

(22) PCT Filed: Oct. 10, 2023
(86) PCT No.: PCT/GB2023/052624

§ 371 Date: Apr. 10, 2025

(30) Foreign Application Priority Data
Oct. 10, 2022 (GB) 2214917.3

(51) Int. Cl. E06B 9/04; E06B 9/06

(52) U.S. Cl. CPC E06B 9/04; E06B 9/0638

(57) ABSTRACT

A shutter assembly including a shutter-style window covering; and a mounting clip, wherein the shutter-style window covering includes a frame that defines an aperture, and a plurality of vanes that are rotatably coupled to the frame, wherein the vanes have a first orientation in which completely obscure the aperture, and a second orientation in which they partially obscure the aperture; wherein the frame defines a mounting clip receiving portion; wherein the mounting clip is detachably coupled to the mounting clip receiving portion; and wherein the mounting clip includes a window engagement portion via which the mounting clip may be detachably coupled to a window.

The present invention relates to shutter assemblies, in particular shutter assemblies for windows.

Shutter assemblies for windows are well known and have existed for decades. In a typical shutter assembly, a shutter frame is screwed to a window frame and a shutter door is hingedly coupled to the shutter frame. In such an arrangement, the hinge assembly is usually visible and there are gaps between the shutter door and the shutter frame, and sometimes also between the shutter frame and the window frame to which it is secured. The visible hinge assembly may be considered to be aesthetically unpleasing and the gaps between the shutter door and the shutter frame generate unwanted light strike (i.e. unwanted light entering the room from outside via the gaps). Finally, if it is desired to remove a shutter door for any reason, e.g., maintenance or cleaning, either the hinge assembly need to be removed or the shutter frame must be unscrewed from the window frame.

WO2021/156515 describes an alternative shutter assembly which includes an outer frame, an inner frame and a hinged shutter door.

Existing shutter assemblies which include outer frames, optionally inner frames, and hinged shutter door elements tend to be bespoke units and as such tend to be relatively expensive to manufacture and install.

There is therefore a desire to provide a shutter assembly that has the looks of a conventional shutter assembly, but at a significantly lower cost.

The present invention seeks to address one or more of the problems associated with known shutter assemblies.

According to a first aspect of the invention, there is provided a shutter assembly including a shutter-style window covering; and a mounting clip, wherein the shutter-style window covering includes a frame that defines an aperture, and a plurality of vanes that are rotatably coupled to the frame, wherein the vanes have a first orientation in which completely obscure the aperture, and a second orientation in which they partially obscure the aperture; wherein the frame defines a mounting clip receiving portion; wherein the mounting clip is detachably coupled to the mounting clip receiving portion; and wherein the clip includes a window engagement portion via which the mounting clip may be detachably coupled to a window, for example to a window comprising a glazing panel and a bead. The skilled person will understand that a window bead conventionally secures a glazing panel to a window frame. In an embodiment of the invention, the window engagement portion may engage a window bead, for example, the window engagement portion may be disposed between the window bead and the glazing panel.

It will be appreciated that the shutter-style window covering is directly fixed to a window and does not hinge or pivot relative to an outer frame or relative to the window. Thus, the window covering frame is fixed relative to the window to which it is secured. The light transmission through the window is controlled simply by rotating the vanes about their respective rotational axes. The window covering frame and associated vanes may be thought of as a shutter door. Thus, according to the subject invention, a shutter door is secured directly to a window via one or more mounting clips.

If it is desired to access the window or to remove the shutter assembly for cleaning, the window covering frame can be detached from the or each mounting clip and then removed from the window.

Reference herein to the window covering frame defining the mounting clip receiving portion includes a mounting clip receiving portion directly defined by the frame and an arrangement in which an insert element forms part of the frame and the insert element defines the mounting clip receiving portion. In such embodiments, the insert element may be fixed to the frame or it may be detachably coupled to the frame.

In an embodiment of the invention, the window covering frame comprises a top frame member, a bottom frame member and a pair of opposed side frame members (often referred to as “stiles”). Thus, the frame defines a rectangular aperture therewithin. As most windows are rectangular, a rectangular frame is most appropriate.

Suitably, the vanes are rotatably coupled to the opposed side frame members or stiles. Thus, one end of a vane may be rotatably coupled to one of the side frame members and the other end of the vane may be rotatably coupled to the other of the side frame members. In such embodiments, each vane may define a substantially horizontal axis of rotation in use.

The vanes of the subject invention may be as described in PCT/GB2023/050559.

With shutter assemblies, it is often desired to rotate all of the vanes simultaneously. Accordingly, the vanes may be connected together via a connecting element such that rotation of one of the vanes results in a corresponding rotation of all of the vanes, or movement of the connecting element results in the rotation of all of the vanes together.

As noted herein, the window covering frame may be releasably coupled to a window via a detachable coupling between the mounting clip and the mounting clip receiving portion. The detachable coupling may be a friction fit provided between the mounting clip and the mounting clip receiving portion or it may be a snap fit provided between the mounting clip and the mounting clip receiving portion. For example, the mounting clip may include a resiliently deformable locating lug which fits within a corresponding aperture defined by the mounting clip receiving portion. In the context of the subject invention, such an arrangement of a locating lug and a corresponding aperture is considered to be a snap fit arrangement.

In embodiments in which a snap fit coupling is provided between the mounting clip and the mounting clip receiving portion, the mounting clip may include a rib or a lug and the mounting clip receiving portion may define at least one channel or aperture, wherein the rib/lug may be detachably received within the channel/aperture.

In an embodiment of the invention, the mounting clip comprises a resiliently deformable body, wherein the body defines an arcuate central portion; at a first end of the arcuate central portion is defined a planar window engagement portion; and at a second end of the arcuate central portion is defined a planar support platform; and wherein the plane of the engagement portion is substantially orthogonal to the plane of the support platform.

A window typically includes a window frame which extends outwardly from the glazing panel. The arcuate central portion permits the mounting clip to extend beyond the window frame when the window engagement portion is disposed between a window bead/sealing gasket and a glazing panel. It also avoids light strike around the edge of the shutter assembly, as the window covering frame of the shutter assembly may be aligned with the window frame which surrounds the glazing panel.

The arcuate body suitably defines an interior cavity; the planar engagement portion extends inwards towards the interior cavity (e.g., parallel to a radial line which extends inwards from the first end of the arcuate central portion towards the axis of the arc); and the planar support platform extends outwards away from the interior cavity (e.g., parallel to a radial line extending away from the second end of the arcuate central portion). In this arrangement, the planar support platform may be arranged perpendicular to the glazing panel, where it may support a bottom rail, a top rail or one of the stiles of the window covering frame.

It will be appreciated that if more than one mounting clip is coupled to a window, each of the planar support platforms may be arranged perpendicular to the glazing panel. Thus, the planar support platform of a mounting clip coupled to a top window frame member may be parallel to and face an opposing planar support platform of a mounting clip coupled to a bottom window frame member. A similar parallel and facing arrangement may be achieved in relation to planar support platforms of mounting clips coupled to opposite side frame members of the window frame.

In order to achieve an orthogonal arrangement of the support platform plane and the engagement portion plane, the arcuate central portion suitably defines an arc of 90°. In other words, radii which extend to the first and second ends of the arcuate central portion define between them an angle of 90°.

In a further embodiment of the invention, the support platform includes an outwardly extending locating lug or boss which is received within a corresponding aperture defined by the mounting clip receiving portion. The locating lug/boss is suitably resiliently deformable, for example to form a snap fit coupling with the respective mounting clip receiving portion. Thus, the locating lug/boss may be carried on or include a resiliently deformable leg. The locating lug/boss may further include a sloping or ramped leading portion. Such a ramped leading edge may urge the locating lug/boss to deflect as it is displaced towards the respective mounting clip receiving portion. When the locating lug/boss is aligned with the respective mounting clip receiving portion, it may snap back to its rest configuration. The locating lug/boss may further include a stop surface which prevents or resists deflection when urged away from the respective mounting clip receiving portion.

It will be appreciated that the resiliently deformable body of the mounting clip may need to be deflected away from its rest configuration in order to form a detachable coupling with the window covering frame. Accordingly, the mounting clip body may be formed from a metal, for example, steel, such as spring steel.

In alternative embodiments, the mounting clip receiving portion may be defined by a body and the mounting clip receiving portion body may define or carry elements which define the channel. The channel is suitably defined between a pair of spaced apart channel-forming elements. The receiving portion body is suitably coupled to the window covering frame.

In such embodiments, the mounting clip may include one or more ribs.

A single rib and a single channel may result in a fixed distance being defined between the window covering frame and the window. However, it may be desired to vary the distance between the window covering frame and the window. Accordingly, in an embodiment of the invention, the mounting clip receiving portion body defines or carries spaced apart elements which define a plurality of spaced apart channels. Additionally or alternatively, the mounting clip may define a plurality of spaced apart ribs. Thus, the desired distance may be selected by locating the rib(s) in the desired channel(s).

Suitably, the rib(s) are defined towards one end of the mounting clip. Thus, the mounting clip may include a body having a first end portion and the rib or each rib is carried or defined by the first end portion of the body.

Similarly, the window engagement portion of the mounting clip may be located at an opposite end of the mounting clip body. Accordingly, the mounting clip body may include a second end portion and the second end portion carries the window engagement portion.

As noted above, it may be desired for the mounting clip to extend perpendicularly relative to the glazing panel of the window. Accordingly, the second end portion may include a substantially planar body and the window engagement portion may extend substantially perpendicularly from the planar body. It will be appreciated that the window engagement portion suitably lies adjacent to the glazing panel in use. Thus, the window engagement portion may be a planar tab. In such an embodiment, the mounting clip body may extend perpendicularly relative to the glazing panel.

In order to couple the window covering frame more securely to the window, more than one mounting clip may be provided. In such embodiments, the window covering frame may define a plurality of mounting clip receiving portions and each mounting clip receiving portion may have associated with it a respective mounting clip. For example, the top frame member, the bottom frame member and optionally the opposed side frame members may each define at least one respective mounting clip receiving portion.

It will be appreciated that the window to which the shutter assembly may be coupled may be an openable window. Such windows typically include one or more hinges and an operating handle which operates a locking or latching mechanism. As the shutter assembly extends outwards from the window frame, the window covering frame may interfere with the operation of the handle. In order to address this potential issue, the window covering frame may include one or more rebates. Such rebates may be aligned with a window operation handle such that the movement of the handle is not compromised by the window covering frame.

Additionally or alternatively, the shutter assembly may further include a window handle extender element. The window handle extender element may be disposed between the window handle and the window frame to extend the handle beyond the shutter assembly frame.

In addition to the window handle extender element, the shutter assembly may further include a handle extension shaft which either extends the length of the window handle operating shaft or which replaces the window handle operating shaft. For example, the handle extension shaft may include a receiving portion which receives therein a portion of a window handle operating shaft and an extension shaft which extends from the receiving portion.

According to a second aspect of the invention, there is provided a window comprising a window frame; a glazing panel carried within the window frame; a window bead which secures the glazing panel to the window frame; and a shutter assembly as defined anywhere herein in connection with the first aspect of the invention, wherein the window engagement portion of the mounting clip is located between the window bead and the glazing panel; and wherein the window covering frame is coupled to the mounting clip via a coupling defined between the mounting clip receiving portion and the mounting clip.

In an embodiment of the second aspect of the invention, the window frame includes a handle; the shutter assembly frame defines a rebate; and the rebate is aligned with the handle. Additionally of alternatively, the shutter assembly may include a window handle extender element; the window frame includes a handle; and the window handle extender element is disposed between the window frame and the handle, whereby the handle extends beyond the shutter assembly.

The shutter assembly suitably includes two or more mounting clips and the window covering frame suitably include two or more corresponding mounting clip receiving portions. In such embodiments, a first mounting clip may be coupled to a top window frame member and a second mounting clip may be coupled to a bottom window frame member.

In an embodiment of the second aspect of the invention, the window comprises two or more shutter assemblies as defined anywhere herein in connection with the first aspect of the invention, wherein each window covering frame is coupled to the window frame via one or more respective mounting clips. Thus, relatively large windows may be covered by two or more shutter assemblies coupled to the window via the respective mounting clips.

According to a third aspect of the invention, there is provided a mounting clip which is suitable for use with a shutter assembly, wherein the mounting clip comprises a resiliently deformable body, wherein the body defines an arcuate central portion; at a first end of the arcuate central portion is defined a planar window engagement portion; and at a second end of the arcuate central portion is defined a planar support platform; and wherein the plane of the engagement portion is substantially orthogonal to the plane of the support platform. Such mounting clips may be useful for mounting a frame to a window which includes a window frame, a glazing panel and a bead which secures the glazing panel within the frame. In such embodiments, the planar window engagement portion may be inserted between the glazing panel and the bead.

The arcuate body suitably defines an interior cavity; the planar engagement portion extends inwards towards the interior cavity (e.g., parallel to a radial line which extends inwards from the first end of the arcuate central portion towards the axis of the arc); and the planar support platform extends outwards away from the interior cavity (e.g., parallel to a radial line extending away from the second end of the arcuate central portion).

In order to achieve an orthogonal arrangement of the support platform plane and the engagement portion plane, the arcuate central portion suitably defines an arc of 90°. In other words, radii which extend to the first and second ends of the arcuate central portion define between them an angle of 90°.

In a further embodiment of the invention, the support platform includes an outwardly extending locating lug or boss which is received within a corresponding aperture defined by the mounting clip receiving portion. The locating lug/boss is suitably resiliently deformable, for example to form a snap fit coupling with the respective mounting clip receiving portion. Thus, the locating lug/boss may be carried on or include a resiliently deformable leg. The locating lug/boss may further include a sloping or ramped leading portion. Such a ramped leading edge may urge the locating lug/boss to deflect as it is displaced towards the respective mounting clip receiving portion. When the locating lug/boss is aligned with the respective mounting clip receiving portion, it may snap back to its rest configuration. The locating lug/boss may further include a stop surface which prevents or resists deflection when urged away from the respective mounting clip receiving portion.

It will be appreciated that the resiliently deformable body of the mounting clip may need to be deflected away from its rest configuration in order to form a detachable coupling with the window covering frame. Accordingly, the mounting clip body may be formed from a metal, for example, steel, such as spring steel.

According to a fourth aspect of the invention, there is provided a method of coupling a shutter assembly to a window, wherein the shutter assembly is as defined anywhere herein in connection with the first aspect of the invention and the window includes a window frame, a glazing panel and a bead which secures the glazing panel within the window frame; wherein the method includes the steps of disposing the window engagement portion of a top mounting clip between a top portion of the glazing panel and window bead; disposing the window engagement portion of a bottom mounting clip between a bottom portion of the glazing panel and window bead; coupling one of the top mounting clip and bottom mounting clip to a corresponding top mounting clip receiving portion or bottom mounting clip receiving portion; and coupling the other of the top and bottom mounting clips to the corresponding top or bottom mounting clip receiving portion.

In an embodiment of the invention, the mounting clips include a resiliently deformable body and the method includes the step of deflecting the top mounting clip or bottom mounting clip before coupling the other of the top and bottom mounting clips to the corresponding top or bottom mounting clip receiving portion.

In a further embodiment, the shutter assembly includes two top mounting clips and two bottom mounting clips and the method includes the steps of disposing the window engagement portion of the two top mounting clips between a top portion of the glazing panel and window bead in a spaced apart relationship; disposing the window engagement portion of the two bottom mounting clips between a bottom portion of the glazing panel and window bead in a spaced apart relationship; coupling the two top mounting clips or the two bottom mounting clips to corresponding top mounting clip receiving portions or bottom mounting clip receiving portions; and coupling the other of the top and bottom mounting clips to the corresponding top or bottom mounting clip receiving portions.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

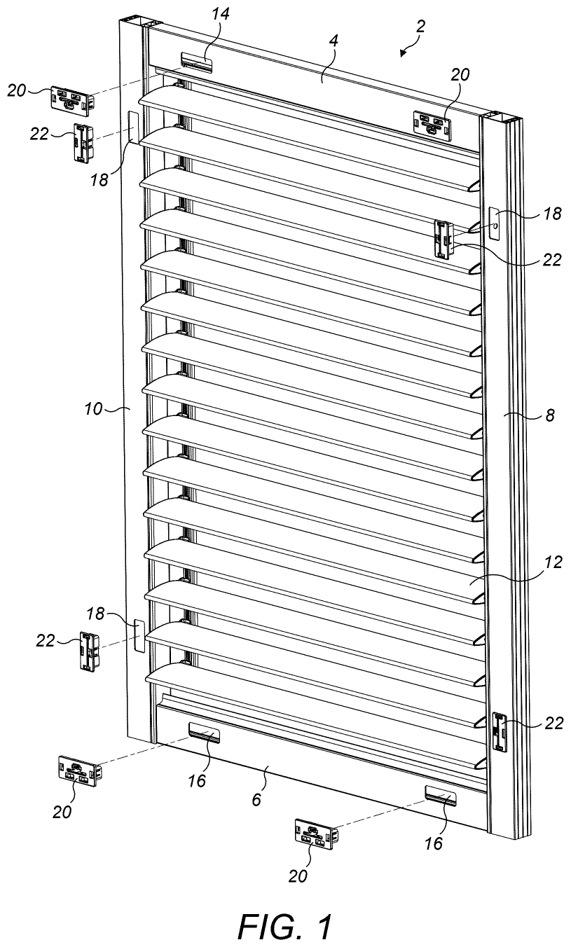

FIG. 1 shows perspective view of a shutter-style window covering of a first embodiment of a shutter assembly according to the first aspect of the invention;

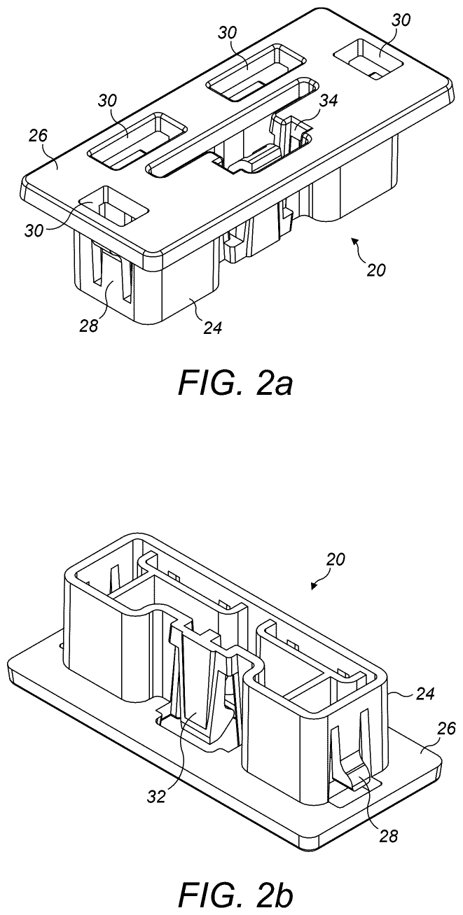

FIGS. 2a and 2b show perspective views of a cross-rail insert which forms part of the shutter-style window covering shown in FIG. 1;

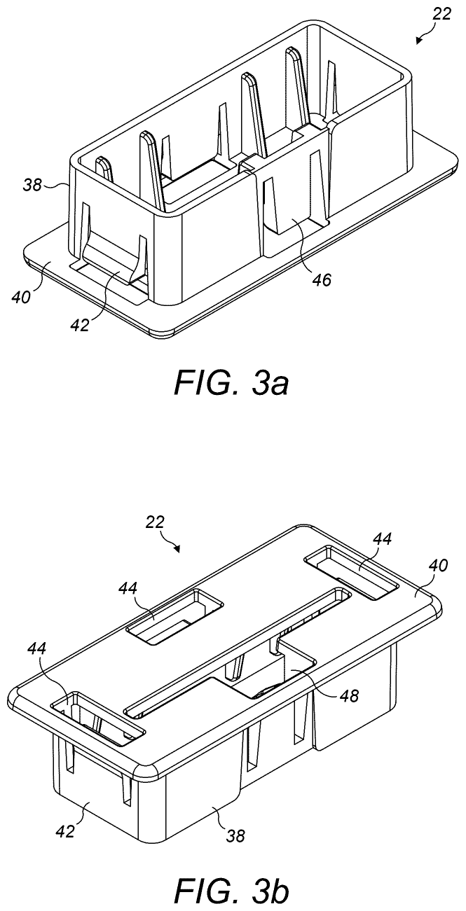

FIGS. 3a and 3b show perspective views of a stile insert which forms part of the shutter-style window covering shown in FIG. 1;

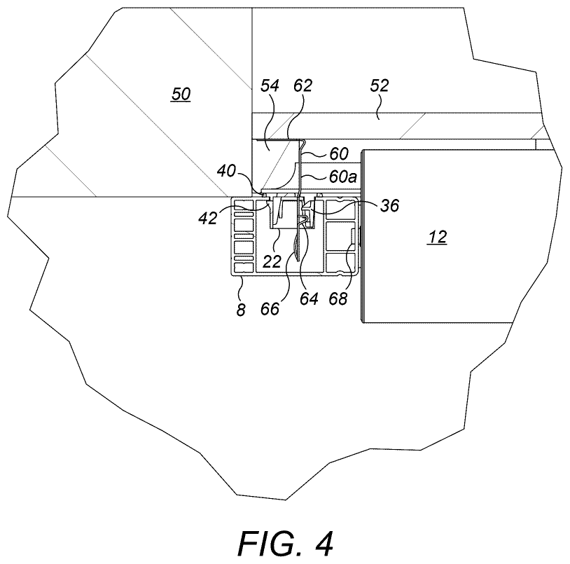

FIG. 4 shows a cross section through a stile of the embodiment shown in FIG. 1 which is secured to a window via a mounting clip;

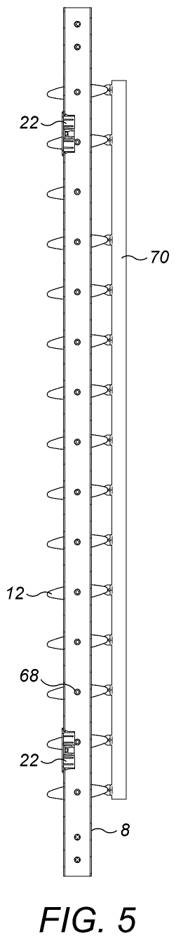

FIG. 5 shows a cross section through a portion of the shutter-style window covering shown in FIG. 1 showing the arrangement of the connecting bar;

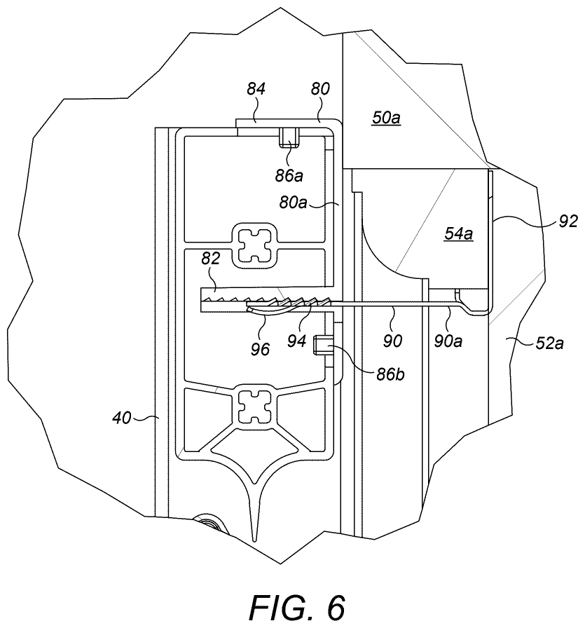

FIG. 6 shows a cross section through a cross-rail which forms part of a second embodiment of a shutter assembly according to the first aspect of the invention;

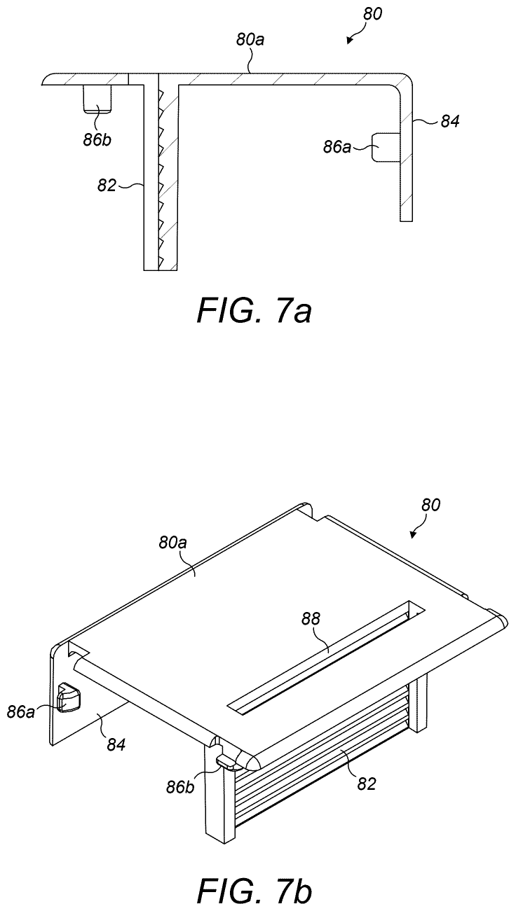

FIGS. 7a, 7b and 7c show an insert which forms part of the second embodiment shown in FIG. 6;

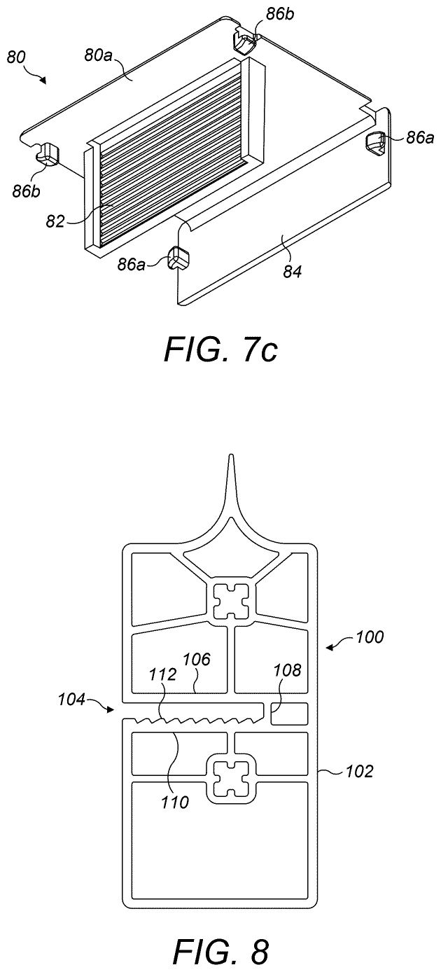

FIG. 8 shows a cross section through a cross-rail of a shutter-style window covering which forms part of a third embodiment of a shutter assembly according to the first aspect of the invention;

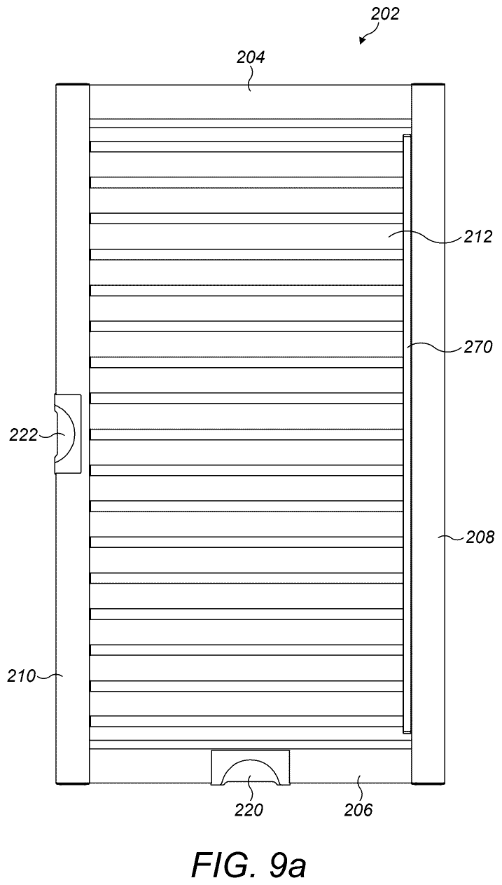

FIGS. 9a and 9b show views of a shutter-style window covering of a fourth embodiment of a shutter assembly according to the first aspect of the invention;

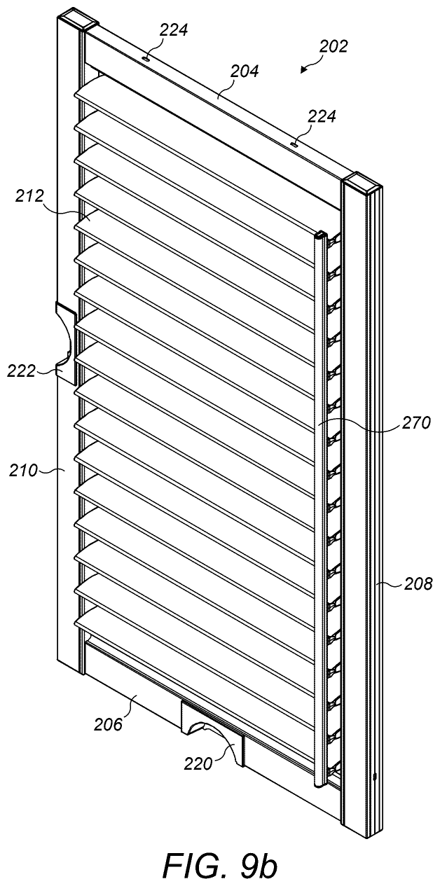

FIG. 10 shows a perspective view of the shutter-style window covering shown in FIGS. 9a and 9b in relation to a window handle;

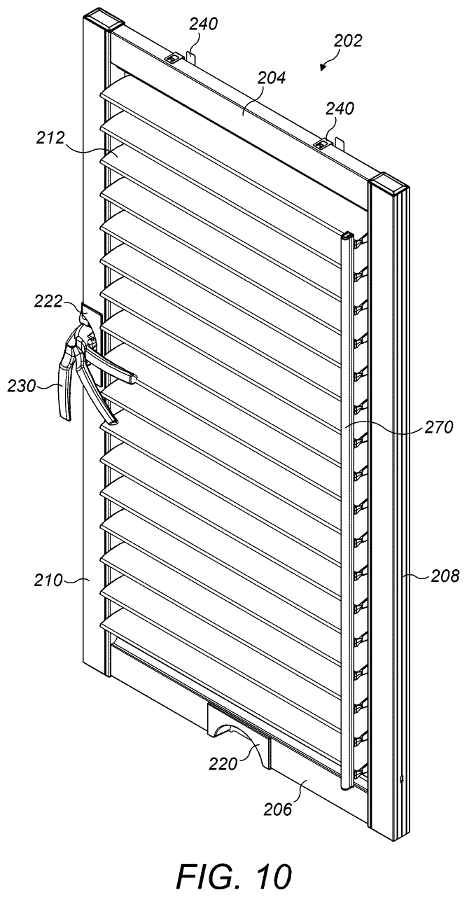

FIG. 11 shows a perspective view of a cross rail rebate cover as shown in FIGS. 9a and 9b;

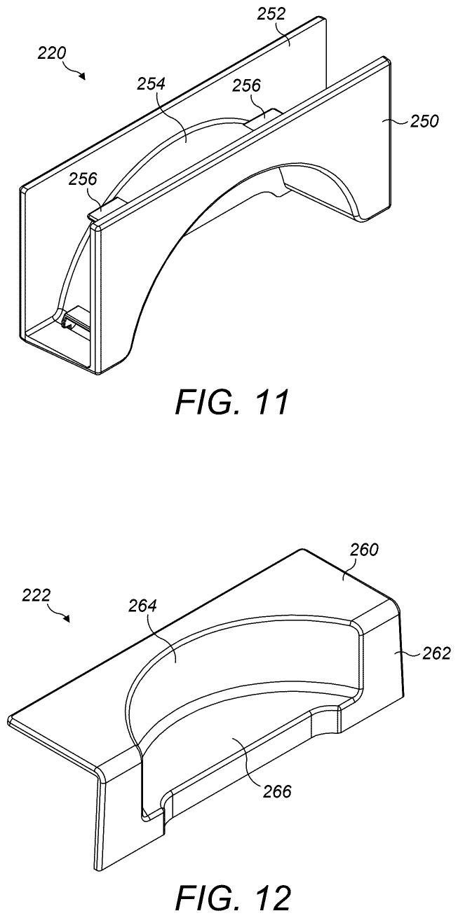

FIG. 12 shows a perspective view of a stile rebate cover as shown in FIGS. 9a and 9b;

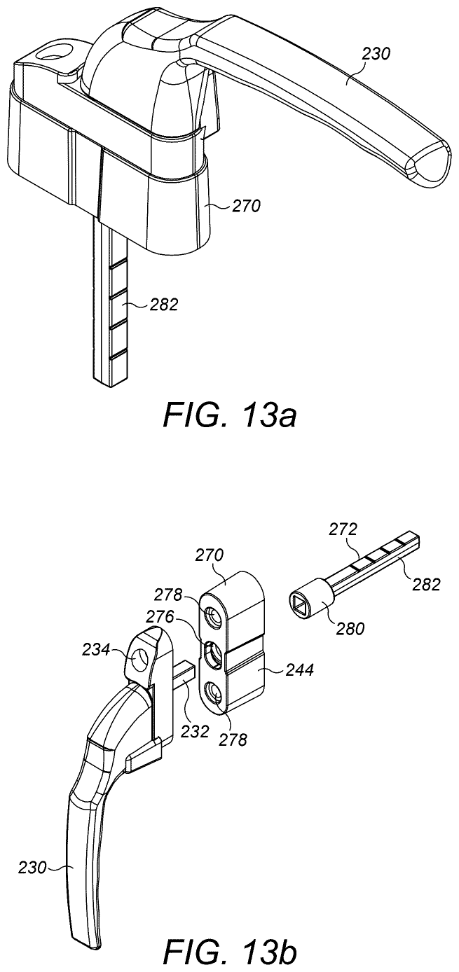

FIGS. 13a and 13b show perspective views of a handle extension kit for use with the shutter-style window covering shown in FIGS. 9a and 9b; and

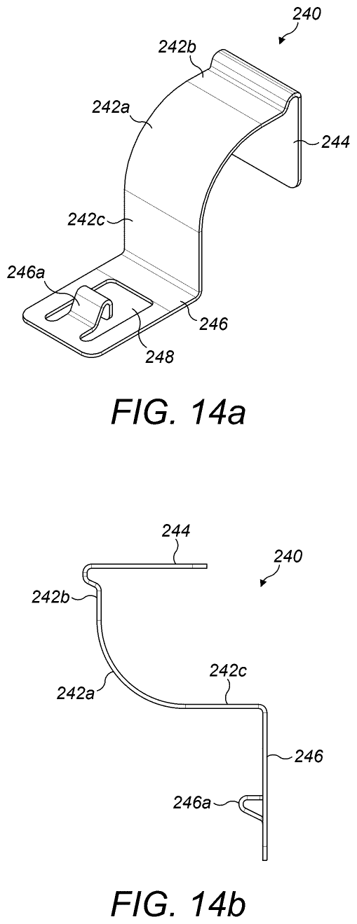

FIGS. 14a and 14b show a mounting clip according to the third aspect of the invention which can be used with the shutter-style window covering shown in FIGS. 9a and 9b.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a shutter-style window covering 2, which forms part of a first embodiment of the invention according to its first aspect. The shutter-style window covering 2 comprises a frame formed from a top rail 4, a bottom rail 6 and a pair of opposed side rails or stiles 8, 10.

A plurality of vanes 12 are rotatably coupled between the opposed stiles 8, 10. Such an arrangement is conventional in window shutters and many arrangements are known for rotatably coupling the vanes 12 between the stiles 8, 10. For example, each vane 12 may include projecting bosses at each end which are rotatably received within respective circular apertures defined by the stiles 8, 10. The axes of rotation of the vanes 12 are each horizontal in use.

The face of the frame which faces towards the window in use defines a number of apertures. In particular, the top rail 4 defines two space apart apertures 14; the bottom rail 6 defines two spaced apart apertures 16; and each of the stiles 8, 10 defines two spaced apart apertures 18. The apertures 14 and 16 receive rail inserts 20, which are shown in more detail in FIGS. 2a and 2b; and the apertures 18 receive stile inserts 22 which are shown in more detail in FIGS. 3 a and 3b.

FIGS. 2a and 2b show in more detail the rail inserts 20. The rail inserts 20 comprise a body 24 which is received by the respective aperture 14, 16 and a face plate 26 which abuts the outwardly facing surface of the top rail 4 or the bottom rail 6.

The body 24 defines four snap fit lugs 28 (only one of which is shown in each of FIGS. 2a and 2b). The snap fit lugs 28 engage the walls of the top rail 4 or the bottom rail 6 which define the apertures 14, 16 to form a snap fit coupling which secures the inserts 20 to the respective rail 4, 6. The snap fit lugs 28 may be accessed via respective apertures 30 defined by the face plate 26. The apertures 30 permit a tool to be inserted therethrough which may be used to disengage the snap fit coupling.

The body 24 further defines a mounting clip receiving portion 32 which is accessed via the aperture 34 defined by the face plate 26. The arrangement of the mounting clip receiving portion 32 will depend on the mounting clip being used. However, in the case of the embodiment shown in FIGS. 1 to 5, the mounting clip receiving portion 32 includes a retaining wall 36 (shown in FIG. 4).

FIGS. 3a and 3b show in more detail the stile inserts 22. The stile inserts 22 are similar to the rail inserts 20 in the sense that they also comprise a body 38 and a face plate 40. The stile inserts define three snap fit lugs 42 (Only one of which is shown in each of FIGS. 3a and 3b). The snap fit lugs 42 engage the walls of the stiles 8, 10 which define the apertures 18 to form a snap fit coupling which secures the inserts 22 to the respective stiles 8, 10. The snap fit lugs 42 may be accessed via respective apertures 44 defined by the face plate 40. The apertures 44 permit a tool to be inserted therethrough which may be used to disengage the snap fit coupling.

As with the rail inserts 20, the body 38 further defines a mounting clip receiving portion 46 which is accessed via the aperture 48 defined by the face plate 40. The arrangement of the mounting clip receiving portion 46 will depend on the mounting clip being used. However, in the case of the embodiment shown in FIGS. 1 to 5, the mounting clip receiving portion 46 includes a retaining wall 36 (shown in FIG. 4), which is the same as the retaining wall 36 for the rail inserts 20.

FIG. 4 shows a cross section through the stile 8 and shows the connection between the stile and a window which comprises a window frame 50, a glazing panel 52 and a glazing bead 54.

The stile 8 is secured to the window via a mounting clip 60. Examples of the mounting clip 60 are shown and described in WO2006/109009. In the embodiment shown in FIG. 4, the mounting clip 60 includes mounting clip body 60a which has at one end thereof a window bead tab 62 which is disposed between the glazing panel 52 and the window bead 54. The window bead tab 62 extends perpendicularly from the body 60a. This arrangement secures the mounting clip 60 to the window. Towards an opposite end of the mounting clip body 60a is provided a locating lug 64 which engages with the retaining wall 36 to detachably couple the stile 8 to the mounting clip 60.

At the far end of the body 60a are a pair of spring biasing elements 66.

FIG. 5 shows a different cross section through the stile 8. Each vane 12 is rotatably coupled to the stile 8 via a projecting boss 68 which is rotatably received within a circular aperture defined by the stile 8. Each of the vanes 12 are pivotally connected to a connecting rod 70. In this arrangement, if the connecting rod 70 is displaced upward or downward, the vanes 12 will all rotate accordingly. Similarly, if any one of the vanes 12 is rotated, the remainder of the vanes 12 will also rotate accordingly. Such an arrangement is common in window shutters and will be well known to the skilled person.

FIGS. 6 and 7a-c show an alternative embodiment of the invention. In this embodiment, the rail insert 20 and the stile insert 22 are replaced with a different insert 80. The insert 80 is shown in more detail in FIGS. 7a-c and includes a serrated portion 82 which defines a plurality of spaced apart channels. Similarly, a mounting clip 90 is used in this embodiment which includes a plurality of ribs instead of a single locating lug 64 as used in the first embodiment. Examples of mounting clips including serrated portions are also shown and described in WO2006/109009 (see, for example, FIGS. 9a and 9b).

Referring to FIGS. 7a-c, the serrated insert 80 includes a main body portion 80a and an end body portion 84. The end body portion 84 is arranged perpendicular to the main body portion 80a and parallel to the serrated portion 82 which projects from one face of the main body portion 80a. The end body portion carries a pair of first snap fit lugs 86a and the main body portion 80a carries a pair of second snap fit lugs 86b which are located on the opposite side of the serrated portion 82 to the end body portion 84.

The main body portion 86a defines a slot 88 adjacent to the serrated portion 82.

Referring now to FIG. 6, a modified top rail 4a is shown. The modified top rail 4a includes a slot defined in one surface which is sized and shaped to receive therein the serrated portion 82 of the serrated insert 80. Additionally, apertures are defined by the modified top rail 4a which receive therein and retain the first and second snap fit lugs 86a, 86b. This arrangement secures the serrated insert 80 to the modified top rail 4a.

Similar to the arrangement shown in FIG. 4, the serrated mounting clip 90 includes a main body portion 90a, at a first end thereof is provided a window bead tab 92. The window bead tab 92 is disposed between a glazing panel 52a and a glazing bead 54a, which in turn is secured to a window frame 50a. A second end portion of the main body portion 90a, which is opposite to the window bead tab 92, carries a plurality of ribs and is inserted into the slot 88. The slot 88 forces the plurality of ribs carried by the second end portion of the serrated mounting clip into engagement with the plurality of channels defined by the serrated portion 82 of the serrated mounting clip 80. This arrangement couples the modified top rail 4 to the window via the serrated mounting clip 80. The skilled person will appreciate that the provision of two serrated portion permits the spacing between the modified top rail 4a and the glazing panel 52 a to be varied, which allows for different sized window frames 50a and glazing beads 54a.

Other than the different mounting clips and mounting clip receiving portions, the shutter-style window covering is identical to that described above and shown in FIGS. 1 to 5.

It will be appreciated that a bottom rail may be provided with corresponding serrated inserts 80. Similarly, a pair of stiles may be provided which also include apertures to receive corresponding serrated inserts 80.

Referring now to FIG. 8, this figure shows a modified bottom rail 100 in which a body 102 defines an aperture 104. The aperture is defined by a top wall 106, an end wall 108 and a bottom wall 110. The bottom wall 110 defines a serrated portion 112 which defines a plurality of spaced apart channels. The aperture 104 receives therein the serrated mounting clip 90 as defined above in connection with FIG. 6. Thus, FIG. 8 shows an arrangement in which the bottom rail defines both the aperture 104 and the serrated portion 112, rather than requiring an insert element which defines an aperture and serrated portion.

The skilled person will appreciate that a corresponding top rail is provided. Thus, a top rail which defines one or more apertures 104 may be provided. Similarly, a pair of opposed stiles may be provided, which also define corresponding apertures, which in turn define a serrated portion that is configured to receive therein a serrated mounting clip 90.

Furthermore, a mixture of the top rails, bottom rails, stiles and mounting clips as described hereinabove may be provided, with the mounting clips being coupled to the respective frame-forming members.

FIGS. 9a and 9b show a fourth embodiment of a shutter-style window covering 202, which is similar to the window covering shown in FIG. 1. The shutter-style window covering 202 comprises a frame formed from a top rail 204, a bottom rail 206 and a pair of opposed side rails or stiles 208, 210.

A plurality of vanes 212 are rotatably coupled between the opposed stiles 208, 210. As noted above, such an arrangement is conventional in window shutters and many arrangements are known for rotatably coupling the vanes 212 between the stiles 208, 210. For example, each vane 212 may include projecting bosses at each end which are rotatably received within respective circular apertures defined by the stiles 208, 210. The axes of rotation of the vanes 212 are each horizontal in use.

Each of the vanes 212 is connected to each other via a connecting rod 270, which operates in the same way as the connecting rod 70 discussed hereinabove.

The window covering 202 further includes rebated portions into which respective rebate covers 220, 222 are inserted. Such rebates and rebate covers 220, 222 permit the operation of a window handle when the window covering 202 is in place. This is shown in more detail in FIG. 10 and described in detail below.

As shown in FIG. 9b, locating apertures 224 are defined by the top rail 204. Corresponding locating apertures (not shown) are defined by the bottom rail 206. The purpose of the locating apertures 224 will be explained in more detail hereinbelow.

FIG. 10 shows a shutter-style window covering 202 in position relative to a window operating handle 230. As noted above, it is desired that the shutter-style window covering 202 does not interfere with the operation of the window to which it is attached. In particular, the window covering 202 should not interfere with the operation of the window operating handle 230, which is used to latch or unlatch the window to permit or prevent its opening.

The rebated portion and associated cover 222 permits the rotation of the window operating handle 230 relative to the window covering 202. It will be appreciated by the skilled person that a window may alternatively include an operating handle at the bottom or top thereof. In such cases, the rebated portion and rebate cover 222 would permit the operation of the window operating handle.

FIG. 10 also shows two mounting clips 240 which retain the shutter-style window covering 202 relative to a window frame and glazing panel. The mounting clips 240 are described and discussed in more detail below.

FIG. 11 shows in more detail the cross rail rebate cover 220. The rebate cover 220 comprises an arched front wall 250, a rectangular rear wall 252 and a curved intermediate wall 254 which joins the front wall 250 to the rear wall 252. Such a rebate cover permits the rotation of the window handle 230 within the concave portion defined by the front wall 250 and the intermediate wall 254.

The rebate cover 220 is retained in place via a pair of locating tabs 256, which may either be received by respective apertures defined by the cross rail 206 or which engage an upwardly facing surface of the cross rail 206. The rebate cover 220 suitably forms a friction fit within the aperture defined by the cross rail 206.

FIG. 12 shows in more detail the stile rebate cover 222. The rebate cover 222 comprises an arched front wall 260 and a side wall 262 arranged perpendicularly to the front wall 260. The front wall defines a rectangular-shaped cut out portion. The cavity defined by the rebate cover 222 is bounded by a curved wall 264 and a planar wall 266. As with the rebate cover 220, the rebate cover may be coupled to the stile 210 via a friction coupling. However, the rebate cover 222 may further include a securing element (not shown) which may be engaged with a portion of the stile 210.

FIGS. 13a and 13b shows the window handle 230 with an optional extension kit which includes a spacer element 270 and an extension rod 272. The spacer element 270 includes a body 274 which defines a central bore 276 and a pair of through holes 278. The central bore 276 receives on one side a portion of an operating rod 232 of the window handle 230, and on the other side a head portion 280 of the extension rod 272. The head portion 280 of the extension rod 272 defines a rectangular aperture which receives therein an end portion of the rectangular-shaped operating rod 232, such that rotation of the window handle 230 causes rotation of the operating rod 232. The engagement of the distal end of the operating rod 232 within the head portion 280 of the extension rod 272 results in a corresponding rotation of the extension rod 272. The extension rod 272 further includes a rectangular-shaped rod portion 282 which has the same cross-sectional shape and size as the window handle operating rod 232. The rectangular-shaped rod portion 282 engages with a latch mechanism (not shown) of the window, wherein rotation of the window handle 230 causes a rotation of the window handle operating rod 232 and a corresponding rotation of the extension rod 272.

The through holes 278 are aligned with corresponding holes 234 defined by the window handle such that the window handle may be secured to the window in the same way, but using longer fixings which pass through the holes 234 and 278.

The extension kit comprising the spacer element 270 and the extension rod 272 thereby spaces the window handle 230 from the handle without interfering with the operation of the window handle 230.

FIGS. 14a and 14b show in more the detail the mounting clip 240. The mounting clip 240 includes an arcuate body portion 242a. At one end of the arcuate body portion 242a is a first extension portion 242b. At the opposite end of the arcuate body portion 242a is a second extension portion 242c

A planar window engagement portion 244 extends from the first extension portion 242b in the general direction of the axis of the arcuate portion 242a (i.e., into the cavity defined by the arcuate portion 242a and extension portions 242b, 242c).

A planar window covering engagement portion 246 extends from the second extension portion 242c in a direction which is away from the cavity defined by the arcuate portion 242a and extension portions 242b, 242c.

In this arrangement, the plane of the window engagement portion 244 is orthogonal to the plane of the window covering engagement portion 246.

The arcuate portion 242a and extension portions 242b, 242c permit the window covering engagement portion 246 to extend around the window frame of the window and to extend perpendicular to the glazing panel.

The window covering engagement portion 246 defines therein an aperture 248. A locating lug 246a extends from a part of the window covering engagement portion 246 into the aperture 248. The locating lug 246a also extends out of the plane of the window covering engagement portion 246.

The locating lug 246a is resiliently deformable relative to the window covering engagement portion 246. It includes a sloped or ramped leading edge portion and a rear stop surface which is substantially perpendicular to the window covering engagement portion 246.

The mounting clips are formed from spring steel, so that they are resiliently deformable.

In use, a first pair of mounting clips 240 are coupled to a top portion of a window by inserting the window engagement portion 244 of each clip between the glazing panel and a gasket disposed between the glazing panel and a top frame member of the window frame. A corresponding second pair of mounting clips 240 are coupled to a bottom portion of the window by inserting the window engagement portion 244 of each clip between the glazing panel and a gasket disposed between the glazing panel and a bottom frame member of the window frame. In this way, the window covering engagement portion 246 of each of the clips extends perpendicularly away from the glazing panel. Furthermore, each of the top mounting clips 240 faces a corresponding bottom mounting clip.

The locating lugs 246a of the top mounting clips 240 are disposed within the respective locating apertures 224 defined by the top rail 204. The frame of the window covering 202 is then urged upwards, which causes the top mounting clips 240 to be deflected. In this configuration, the locating lugs 246a of the bottom mounting clips 240 are disposed within the respective locating apertures (not shown) defined by the bottom rail 206. The frame of the window covering 202 is then released.

Once released, the top mounting clips 240 will exert a downward force on the top rail 204 and the bottom mounting clips 240 will exert an upward force on the bottom rail 206. These forces maintain the locating lugs 246a of the mounting clips 240 in their respective locating apertures 224. This in turn prevents or restricts the displacement of the window covering 202 away from the window

Furthermore, the bottom mounting clips 240 support the weight of the window covering 202.

It will be appreciated that a relatively simple mounting clip 240 is able to retain in place the window covering 202, which makes the shutter assembly of the invention relatively cheap to produce and easy to install.

1. A shutter assembly including a shutter-style window covering; and
a mounting clip, wherein the shutter-style window covering includes a frame that defines an aperture, and a plurality of vanes that are rotatably coupled to the frame, wherein the vanes have a first orientation in which completely obscure the aperture, and a second orientation in which they partially obscure the aperture; wherein the frame defines a mounting clip receiving portion; wherein the mounting clip is detachably coupled to the mounting clip receiving portion; and wherein the mounting clip includes a window engagement portion via which the mounting clip may be detachably coupled to a window.

2. A shutter assembly according to claim 1, wherein the window covering frame comprises a top frame member, a bottom frame member and a pair of opposed side frame members.

3. A shutter assembly according to claim 2, wherein the vanes are rotatably coupled to the opposed side frame members.

4. A shutter assembly according to claim 1, wherein the vanes are connected together via a connecting element such that rotation of one of the vanes results in a corresponding rotation of all of the vanes, or movement of the connecting element results in the rotation of all of the vanes together.

5. A shutter assembly according to claim 1, wherein the mounting clip forms a friction fit or a snap fit within the mounting clip receiving portion.

6. A shutter assembly according to claim 5, wherein the mounting clip comprises a resiliently deformable body, wherein the body defines an arcuate central portion; at a first end of the arcuate central portion is defined a planar window bead engagement portion; and at a second end of the arcuate central portion is defined a planar support platform; and wherein the plane of the engagement portion is substantially orthogonal to the plane of the support platform.

7. A shutter assembly according to claim 6, wherein the arcuate body defines an interior cavity; the planar engagement portion extends inwards towards the interior cavity; and the planar support platform extends outwards away from the interior cavity.

8. A shutter assembly according to claim 6, wherein the arcuate central portion defines an arc of 90°.

9. A shutter assembly according to claim 6, wherein the support platform includes an outwardly extending locating lug which is received within a corresponding aperture defined by the mounting clip receiving portion.

10. A shutter assembly according to claim 6, wherein the resiliently deformable body is formed from steel.

11. A shutter assembly according to claim 1, wherein the window covering frame defines a plurality of mounting clip receiving portions and each mounting clip receiving portion has associated with it a respective mounting clip.

12. A shutter assembly according to claim 11, wherein the top frame member and the bottom frame member each define at least one respective mounting clip receiving portion.

13. A shutter assembly according to claim 1, wherein the window covering frame defines one or more rebates.

14. A window comprising a window frame; a glazing panel carried within the window frame; a window bead which secures the glazing panel to the window frame; and a shutter assembly; wherein the shutter assembly includes a shutter-style window covering; and a mounting clip, wherein the shutter-style window covering includes a frame that defines an aperture, and a plurality of vanes that are rotatably coupled to the frame, wherein the vanes have a first orientation in which completely obscure the aperture, and a second orientation in which they partially obscure the aperture; wherein the frame defines a mounting clip receiving portion;
wherein the mounting clip is detachably coupled to the mounting clip receiving portion; and wherein the mounting clip includes a window engagement portion via which the mounting clip may be detachably coupled to a window; wherein the window engagement portion of the mounting clip is located between the window bead and the glazing panel; and wherein the window covering frame is coupled to the mounting clip via a coupling defined between the or each mounting clip receiving portion and the respective mounting clip.

15. A window according to claim 14, wherein the window frame includes a handle; the window covering frame defines a rebate; and the rebate is aligned with the handle.

16. A window according to claim 15, wherein the shutter assembly further includes a window handle spacer element and the window handle spacer element is disposed between the window handle and the window frame.

17. A window according to claim 14, wherein the window comprises two or more shutter assemblies as defined in any of claims 1 to 13, wherein each window covering frame is coupled to the window frame via one or more respective mounting clips.

18. A mounting clip for use with a shutter assembly comprising a resiliently deformable body, wherein the body defines an arcuate central portion; at a first end of the arcuate central portion is defined a planar window bead engagement portion; and at a second end of the arcuate central portion is defined a planar support platform; and wherein the plane of the engagement portion is substantially orthogonal to the plane of the support platform.

19. A mounting clip according to claim 18, wherein the arcuate body defines an interior cavity; the planar engagement portion extends inwards towards the interior cavity; and the planar support platform extends outwards away from the interior cavity.

20. A mounting clip according to claim 18, wherein the arcuate central portion defines an arc of 90°.

21. A mounting clip according to claim 18, wherein the support platform includes an outwardly extending locating lug.

22. A mounting clip according to claim 18, wherein the resiliently deformable body is formed from steel.
